(19) United States
(12) Patent Application Publication
(10) Pub. No.: US 2022/0329451 A1
(43) Pub. Date: Oct. 13, 2022

(54) INFORMATION PROCESSING APPARATUS

(71) Applicant: SHARP KABUSHIKI KAISHA, Osaka (JP)

(72) Inventor: KIHO SAKAMOTO, Osaka (JP)

(21) Appl. No.: 17/851,516

(22) Filed: Jun. 28, 2022

Related U.S. Application Data
(62) Division of application No. 16/415,956, filed on May 17, 2019.

(30) Foreign Application Priority Data
May 31, 2018 (JP) 2018-105202

(51) Int. Cl. H04L 12/18; H04L 51/08; H04L 51/42

(52) U.S. Cl. CPC H04L 12/1831; H04L 51/08; H04L 12/1822; H04L 51/42

(57) ABSTRACT

An information processing apparatus includes a communication port that communicates with an external device and a controller that controls the information processing apparatus. The controller performs control to acquire an email via the communication port and to start up an application in response to startup information when it is determined that the email includes the startup information.

### BACKGROUND

### 1. Field

The present disclosure relates to an information processing apparatus.

### 2. Description of the Related Art

Information processing apparatuses, such as a large-scale display, have been now widely used in conferences, meetings, and lectures for conducting a meeting or the like efficiently. Applications running in the information processing apparatus have also been widely used. For example, an application for communications with a remote place is used to conduct a meeting with the remote place. Attendees may be informed of the application for use in the meeting or the like by an email in advance, and the application is started up in each conference place on the day of the meeting.

Japanese Unexamined Patent Application Publication No. 2011-223339 proposes a technique that determines whether to start up an application on a large-scale display depending on a given condition. The proposed technique relates to a teleconference system that includes a teleconference operation terminal operating in a teleconference and an attendee terminal of an attendee that participates in the teleconference. The teleconference operation terminal includes a conference program applied to the teleconference, a recognition count determination unit, and a conference program startup unit. The recognition count determination unit determines a recognition count in accordance with attendee terminals recognized by an attendee terminal recognition unit that recognizes each attendee terminal. The conference program startup unit starts up the conference program when the recognition count determination unit determines that the recognition count equals a preset recognition count.

The proposed technique has a difficulty in acquiring an email, identifying in accordance with the contents of the email an application to be used in the conference, and starting up the application when the conference commences.

It is desirable to provide an information processing apparatus that starts up an appropriate application in response to a received email.

### SUMMARY

According to an aspect of the disclosure, there is provided an information processing apparatus. The information processing apparatus includes a communication port that communicates with an external device and a controller that controls the information processing apparatus. The controller performs control to acquire an email via the communication port and to start up an application in response to startup information when it is determined that the email includes the startup information.

An information processing apparatus includes a communication port that communicates with an external device, a controller that controls the information processing apparatus, and a memory that stores log information on an application that has been used. The controller performs control to determine in accordance with the log information whether a frequent usage application satisfying a frequent usage application condition is present when an email has been received via the communication port, and to start up the frequent usage application when the frequent usage application is present.

### BRIEF DESCRIPTION OF THE DRAWINGS

FIG. 1 illustrates the whole configuration of a first embodiment;

FIG. 2 is a functional block diagram illustrating a management server of the first embodiment;

FIG. 3 illustrates schedule information of the first embodiment;

FIG. 4 illustrates email information of the first embodiment;

FIG. 5 is a functional block diagram illustrating a display of the first embodiment;

FIG. 6 illustrates user information of the first embodiment;

FIG. 7 illustrates startup application information of the first embodiment;

FIG. 8 is a flowchart of a process of the first embodiment;

FIG. 9 is a flowchart of the process of the first embodiment;

FIGS. 10A and 10B illustrate an operation example of the first embodiment;

FIG. 11 illustrates an operation example of the first embodiment;

FIG. 12 illustrates startup information of a second embodiment;

FIG. 13 is a flowchart illustrating a process of the second embodiment;

FIG. 14 illustrates the whole configuration of a third embodiment;

FIG. 15 is a functional block diagram illustrating a display of the third embodiment;

FIG. 16 illustrates email information of the third embodiment;

FIG. 17 is a flowchart illustrating a process of the third embodiment;

FIG. 18 illustrates startup application information of a fourth embodiment;

FIG. 19 is a flowchart illustrating a process of the fourth embodiment;

FIG. 20 is a functional block diagram illustrating a display of a fifth embodiment;

FIG. 21 illustrates startup application information of the fifth embodiment;

FIG. 22 illustrates application usage log information of the fifth embodiment;

FIG. 23 is a flowchart illustrating a process of the fifth embodiment; and

FIG. 24 is a flowchart illustrating the process of the fifth embodiment.

### DESCRIPTION OF THE EMBODIMENTS

Embodiments of the disclosure are described with reference to the drawings. A display including an information processing apparatus of the embodiments is described below.

### 1 FIRST EMBODIMENT

### 1.1 Whole Configuration

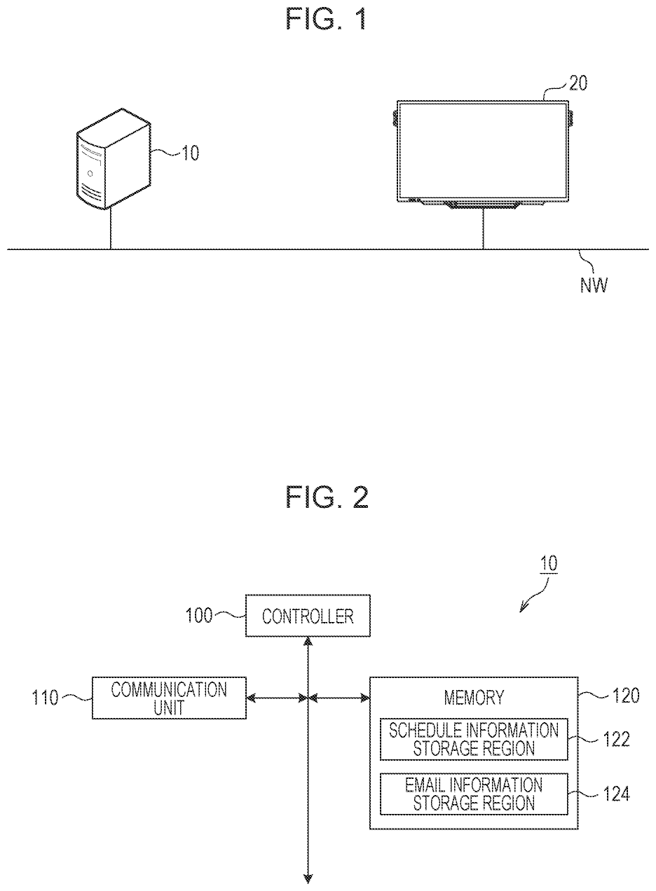

A whole configuration of a first embodiment is described. FIG. 1 illustrates a management server 10 that manages schedule information and a display apparatus 20 that includes an information processing apparatus of a first embodiment of the disclosure. The management server 10 and the display apparatus 20 are connected to each other via a network NW. The network NW may be an Intranet.

The schedule information is related to a schedule of a conference, an event, or a meeting. The schedule information includes information relating to a schedule name, start date and time, and attendees. In accordance with the first embodiment, a schedule managed by the management server 10 is a schedule of a meeting. The management server 10 thus functions as a conference server that reserves a meeting and manages information about the schedule of the reserved meeting.

The display apparatus 20 provides functionalities used by a user, such as a functionality for displaying materials used in a meeting and a functionality for handwriting. The functionalities used by the user may be implemented by an application (hereinafter referred to as an “app”) that is started up on the display apparatus 20.

### 1.2 Functional Block

### 1.2.1 Management Server

The functional blocks of the management server 10 of the first embodiment are described with reference to FIG. 2. Referring to FIG. 2, the management server 10 includes a controller 100, a communication unit 110, and a memory 120.

The controller 100 controls the whole management server 10. The controller 100 performs a variety of functionalities by reading and executing a variety of programs. The controller 100 includes one or more arithmetic devices (such as one or more central processing units (CPUs)).

The communication unit 110 enables the management server 10 to communicate with an external device. The communication unit 110 may be implemented by a network interface card (NIC) used on a wired and/or wireless local-area network (LAN) or a communication module that is connectable with a long-term evolution (LTE) network, an LTE-Advanced (LTE-A) network, a license-assisted access (LAA) network using LTE, or a 5G network.

The memory 120 stores a variety of programs used to operate the management server 10 and a variety of data. The memory 120 may include a solid state drive (SSD) that is a semiconductor memory, a hard-disk drive (HDD) and the like.

The memory 120 includes a schedule information storage region 122 and an email information storage region 124. The schedule information storage region 122 stores the schedule information. The email information storage region 124 stores information (hereinafter referred to as “email information”) that associates the contents of an email received by the management server 10 with the schedule information corresponding to that email.

In accordance with the first embodiment, the management server 10 receives an email describing the contents of the schedule of a meeting (hereinafter referred to as “invitation email”) and provides a functionality to receive a reservation of the meeting. The management server 10 extracts the contents of the schedule of the meeting from the invitation email and stores on the schedule information storage region 122 the contents of the schedule as the schedule information. The management server 10 stores the contents of the invitation email on the email information storage region 124. The management server 10 having received the invitation email may transmit (transfer) the invitation email to the attendees of the meeting via the communication unit 110.

In accordance with the first embodiment, information about the schedule name (meeting name), the name of the attendees, and the start date and time is extracted as the contents of the schedule of the meeting from the invitation email. In order to extract the schedule information from the invitation email, the text body of the invitation email is analyzed and the location where the schedule name (meeting name), the names of the attendees, and the start date and time are written is identified, and the written contents are thus extracted. The management server 10 may provide a form that accepts the contents of the schedule and the sentence for the notice of the meeting and enable a user to enter these pieces of information onto the form. In such a case, the management server 10 may store the contents of the schedule as the schedule information and store as the email information the sentence for the notice of the meeting and a schedule identification (ID) that is attached when the contents of the schedule are stored as the schedule information.

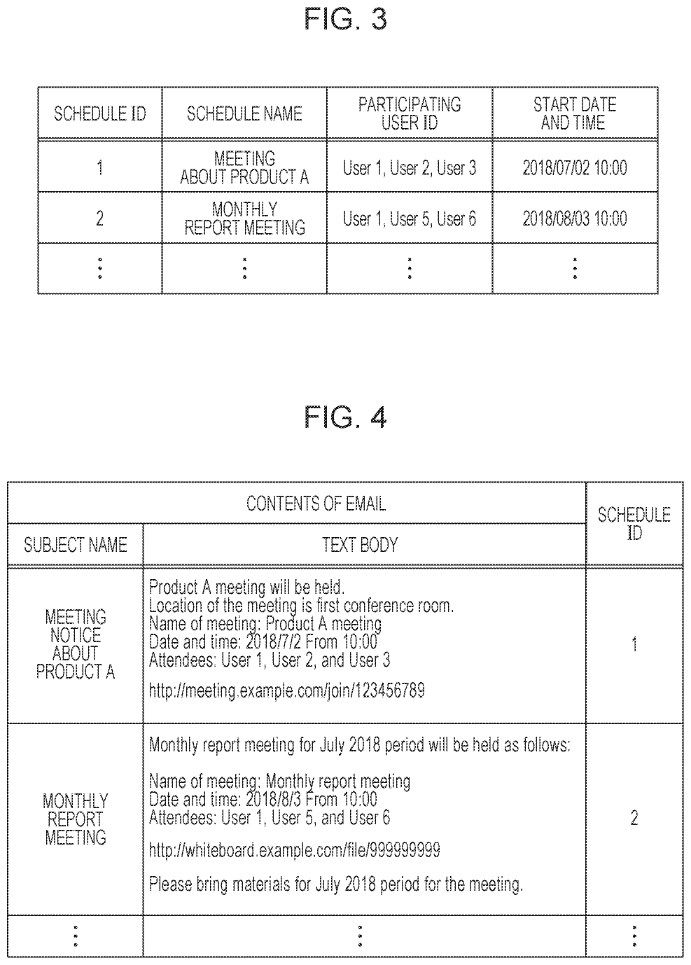

Referring to FIG. 3, the schedule information stored includes the schedule ID used to identify the schedule information (for example, “1”), the schedule name serving as the meeting name (for example, “Product A meeting”), and attendee user IDs used to identify the attendees participating in the meeting (for example, “User 1,” “User 2,” “User 3”), and the start date and time of the meeting (for example, “2018/07/02 10:00”).

The schedule ID is a serial number that the management server 10 attaches to the schedule when, for example, the schedule information is stored. It is noted that the schedule ID may be a code that the management server 10 attaches to the schedule in accordance with a predetermined format or may be a random character string.

The attendee user IDs may be one or more user IDs corresponding to the attendees in the contents of the schedule. The user ID may be a character string including alphabets and numerals and is different from user to user. Information identifying a user participating in the meeting may not necessarily have to be a user ID and may be the name, an email address, or an employee number of the user.

The contents of the schedule may include in addition to the schedule name, the names of the attendees, and the start date and time of the meeting, the organizer, the venue, and the scheduled end date and time of the meeting. In such a case, information about the organizer, the venue, and the scheduled end date and time of the meeting is also stored in the schedule information.

Referring to FIG. 4, the email information stored includes the subject name of the email (for example, “Meeting notice about Product A”), the text body of the email (for example, “Product A meeting will be held”), and a schedule ID identifying the schedule information corresponding to the invitation email (for example, “1”). It is noted that the subject name of the email and the text body of the email out of the contents of the invitation email are referred to as email contents or contents of an email.

The schedule ID is attached by the management server 10 to the schedule when the schedule input by the user is stored as the schedule information. Since the schedule of the meeting and the contents of the invitation email are input by the user, the management server 10 may store the email contents of the invitation email and the corresponding schedule ID by using the schedule ID attached when the schedule information is stored.

The invitation email may include an attached file and information on a contact address. In such a case, the email contents of the email information including the information on the contact address and the attached file are stored. The attached file may be directly stored in the email information. Alternatively, a storage region used to store the attached file may be arranged on the memory 250 and the location where the attached file is stored may be stored as the email contents.

### 1.2.2 Display

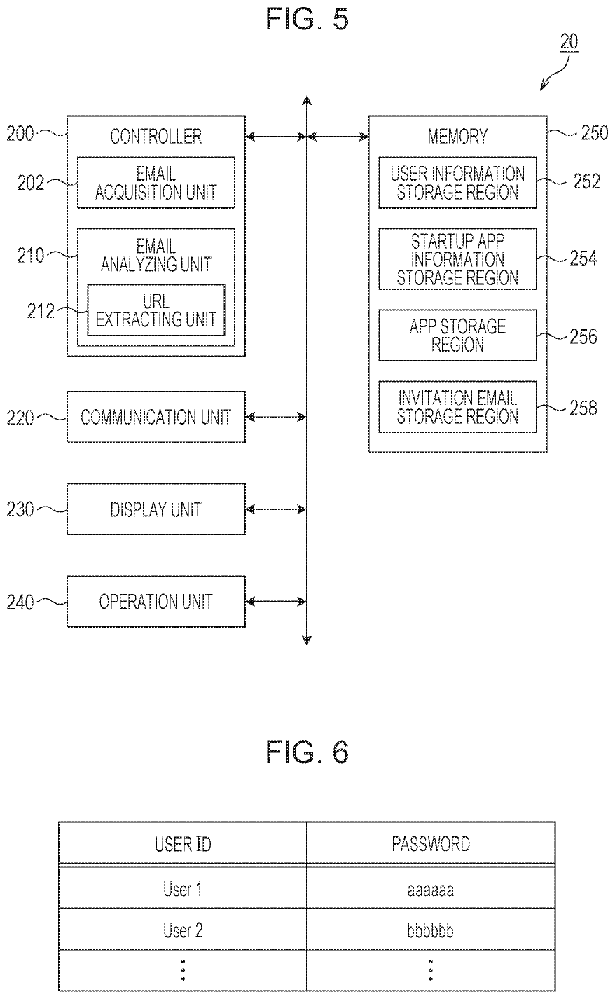

The functional block diagram of the display apparatus 20 is described with reference to FIG. 5. Referring to FIG. 5, the display apparatus 20 includes a controller 200, an email analyzing unit 210, a communication unit 220, a display unit 230, an operation unit 240, and a memory 250.

The controller 200 controls the whole display apparatus 20. The controller 200 implements a variety of functionalities by reading and executing a variety of programs. The controller 200 includes one or more arithmetic devices (such as CPUs).

The controller 200 functions as the email acquisition unit 202 and the email analyzing unit 210 by reading a program from the memory 250 and executing the read program.

The email acquisition unit 202 acquires the contents of an email from the management server 10. The email acquisition unit 202 acquires the email contents by transmitting an email content acquisition request to the management server 10. Upon receiving the email content acquisition request, the management server 10 transmits the email contents to the display apparatus 20 in accordance with the email information stored on the email information storage region 124. The email acquisition unit 202 acquires the email contents received from the management server 10 via the communication unit 220.

When part of the email information of the email contents stored on the email information storage region 124 is acquired, the email acquisition unit 202 narrows the email contents acquired from the management server 10 in accordance with a corresponding schedule ID included in the email information or a character string included in the subject name. A condition applied to narrowing the email contents is referred to as a narrowing condition. The email acquisition unit 202 acquires the email contents satisfying the narrowing condition by transmitting the narrowing condition together with the email content acquisition request to the management server 10. For example, if an invitation email corresponding to the schedule information having a schedule ID of 1 is to be acquired, the email acquisition unit 202 sets the narrowing condition to “corresponding schedule ID=1”, and then transmits the narrowing condition together with the email content acquisition request to the management server 10. The management server 10 transmits to the display apparatus 20 the email contents of the email information matching the corresponding schedule ID specified as the narrowing condition. By using the schedule ID, the email contents of the invitation email corresponding to specific schedule information are thus obtained.

The email analyzing unit 210 analyzes the email contents received from the management server 10 via the communication unit 220 and outputs analysis result data. In accordance with the first embodiment, the email analyzing unit 210 outputs the subject name and the text body from the email contents acquired by the email acquisition unit 202. If the attached file is included in the email contents, that attached file is excluded. In an optional operation, a text portion may be extracted from a hypertext markup language (HTML) email.

In accordance with the first embodiment, the email analyzing unit 210 performs the functionality of the uniform resource locator (URL) extracting unit 212. The URL extracting unit 212 extracts URL included in the text body in the email contents and outputs a list of extracted URLs as the analysis result data. The URL extracting unit 212 extracts a URL from an input sentence by using one of the methods of the related art. For example, the URL extracting unit 212 extracts a URL by extracting a character string matching a pattern of a regular expression for detecting the URL.

The communication unit 220 enables the display apparatus 20 to communicate with an external device. For example, the communication unit 220 may include a network interface card (NIC) used on a wired and/or wireless local-area network (LAN) or a communication module that is connectable with a long-term evolution (LTE) network, an LTE-Advanced (LTE-A) network, a license-assisted access (LAA) network using LTE, or a 5G network.

The display unit 230 displays a variety of information to a user. The display unit 230 may include a liquid-crystal display (LCD) or an organic electroluminescence display (OELD).

The operation unit 240 detects an operation performed by the user. The operation performed by the user may be an operation performed by touching or an operation performed by using an electronic pen. When the user performs an operation, the operation unit 240 detects the number of touch operations, the location of touching, or a contact location where the electronic pen touches. The method of detecting the touching operation may be based on an electrostatic capacity system. Alternatively, the method of detecting the touching operation may be one of techniques of the related art, such as using a resistive membrane system or an infrared light system.

The memory 250 stores a variety of data and a variety of programs used to operate the display apparatus 20. For example, the memory 250 includes a hard-disk drive (HDD) and/or a solid-state drive (SSD) as a semiconductor memory.

The memory 250 further includes a user information storage region 252, a startup app information storage region 254, an app storage region 256, and an invitation email storage region 258.

The user information storage region 252 stores user information used to authenticate a user who operates the display apparatus 20. As illustrated in FIG. 6, the user information includes a user ID to identify a user (such as “User 1”) and a password (such as “aaaaaa”).

The startup app information storage region 254 stores startup app information. The startup app information associates startup information with an app that starts up when the startup information is included. The startup information includes a specific character string included in an email, the schedule information, and information on the user of the display apparatus 20. For example, if a specific character string (such as a domain name, a scheme name, and an extension of a file) is included in the URL included in the text body of the invitation email, the URL including the specific character string is the startup information.

In accordance with the first embodiment, information or an attribute that is referenced in a determination as to whether a specific character string is included is referred to as the type of the startup information.

(1) URL: URL included in the text body of an email and including a specific character string serves as the startup information.

(2) Subject name: The subject name of the email including the specific character string serves as the startup information.

(3) File path: A file path included in the text body of the email or a file attached to the email serves as the startup information.

(4) File name: From among file paths, a file path including a specific file name serves as the startup information.

(5) Extension: A specific extension included in a file name of a file path serves as the startup information.

(6) Scheme name: From among URLs, a URL including a specific scheme name serves as the startup information.

(7) User ID: A specific user ID of a user operating the display apparatus 20 serves as the startup information.

The file path represents a storage location of a file. For example, the file path may be a character string that is formed by linking a drive letter, a directory name, and a file name with delimiters inserted therebetween or a URL including a scheme name indicating the location of the file (such as “file://”).

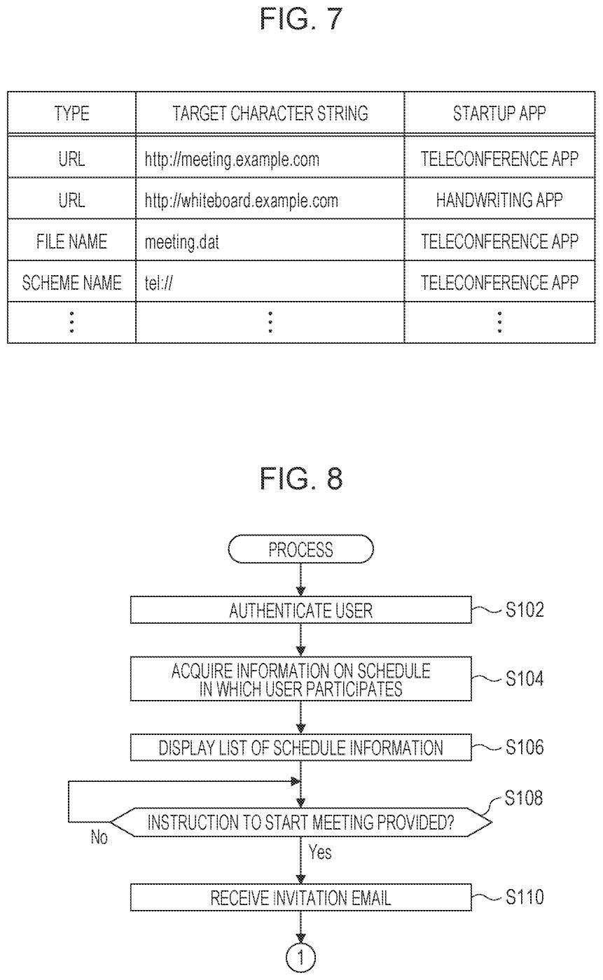

Referring to FIG. 7, the startup app information stored on the startup app information storage region 254 includes the type of the startup information (for example, a URL), a target character string indicating a character pattern as the startup information (for example, “http://meeting.example.com”), and a startup app indicating an app that starts up when the startup information is included (for example, a “teleconference app”).

The type of the startup information may be “URL” and the target character string may be “http://meeting.example.com.” If “http://meeting.example.com” is included as “URL” in the text body of the email, the startup app is started up (executed) in accordance with the URL included in the invitation email as the startup information.

A whole or partial match of the URL is acceptable. In addition to or instead of the URL, a specific character string may be specified as the target character string for the startup information, or a scheme name may be specified as the target character string for the startup information.

Referring to FIG. 7, the target character string is stored on a per type basis. Alternatively, the target character string and the startup app may be simply stored.

The app storage region 256 stores applications (apps). Apps stored on the app storage region 256 include an app stored as the startup app of the startup app information and an app that is executable on another display apparatus 20.

The invitation email storage region 258 stores the email contents of an invitation email acquired by the email acquisition unit 202. The email contents may be stored in the form of a text file or in the form of a table having items for a subject name and a text body.

### 1.3 Process

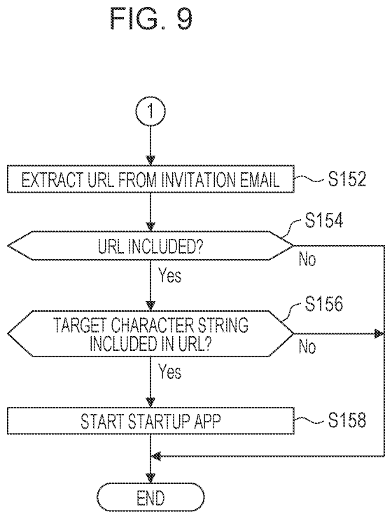

The process of the display apparatus 20 of the first embodiment is described with reference to FIGS. 8 and 9. The controller 200 authenticates a user operating the display apparatus 20 (step S102). Specifically, the controller 200 displays on the display unit 230 a screen that is ready to receive the user ID and the password of the user. If the user ID and password entered by the user match any user information stored on the user information storage region 252, the controller 200 will successfully authenticate the user.

Any user authentication method is acceptable in step S102 as long as the user operating the display apparatus 20 is authenticated. In accordance with the first embodiment, the user is authenticated using the user ID and password input by the user. Alternatively, the user may be authenticated by causing a card reader connected to the display apparatus 20 to read a card that stores information for authentication. Also, biometric authentication, such as iris authentication, fingerprint authentication, or voiceprint authentication, may be employed. Furthermore, the display apparatus 20 may be connected to an authentication server, and the user operating the display apparatus 20 may be authenticated by using an authentication functionality provided by the authentication server.

The controller 200 acquires from the management server 10 the schedule information including the user ID of the user who is an attendee of the schedule and has been authenticated in step S102 (step S104). The management server 10 may provide an application programming interface (API) that returns the schedule information including the specified user ID of the user as an attendee. In such a case, the controller 200 acquires the schedule information by calling the API via the communication unit 220.

The controller 200 displays on the display unit 230 the schedule information acquired in step S104 in the form of a list (step S106). It is acceptable that only part of the schedule information, such as the schedule name or the start date and time, is displayed. The user may select one meeting from the schedule information displayed in the list and determines whether an instruction to start the meeting has been provided (step S108). For example, the instruction to start the meeting may be provided when the user selects a “start” button displayed on the display unit 230.

The controller 200 acquires from the management server 10 the invitation email for the schedule information related to the meeting for which the start instruction has been provided in step S108 (step S110). The controller 200 functions as the email acquisition unit 202, thereby acquiring the email contents of the invitation email from the management server 10. The email acquisition unit 202 then transmits to the management server 10 the email content acquisition request and the narrowing condition. The narrowing condition is satisfied if the corresponding schedule ID matches the schedule ID stored in the schedule information corresponding to the meeting for which the start instruction has been provided in step S108. In this way, the email acquisition unit 202 may acquire the email contents of the invitation email corresponding to the schedule information selected by the user in step S108. The email acquisition unit 202 stores the email contents of the acquired invitation email on the invitation email storage region 258.

Referring to FIG. 9, the controller 200 inputs to the email analyzing unit 210 the email contents of the invitation email stored on the invitation email storage region 258 in step S110. The email analyzing unit 210 reads the text body from the email contents and outputs the text body to the URL extracting unit 212. The URL extracting unit 212 extracts the URL included in the text body of the invitation email (step S152) and outputs the list of extracted URLs as the analysis result data to the controller 200.

The controller 200 determines whether the analysis result data output from the URL extracting unit 212 includes at least one URL (step S154). If the analysis result data does not include any URL, the process ends (no branch from step S154).

If the analysis result data includes at least one URL, the controller 200 reads the URLs from the analysis result data one by one and determines whether the read URL includes a target character string of the startup app information stored on the startup app information storage region 254 (step S156). If the URL includes the target character string (yes branch from step S156), the URL is the startup information. The controller 200 starts up the startup app corresponding to the target character string stored on the startup app information storage region 254 (step S158).

If the analysis result data includes two or more URLs, the controller 200 performs the determination in step S156 on each URL. If the analysis result data includes two or more URLs, each including a target character string, namely, includes two or more pieces of the startup information, the controller 200 may start up the multiple startup apps corresponding to the startup information or may start up a single startup app with the corresponding piece of the startup information set to be active.

### 1.4 Operation Example

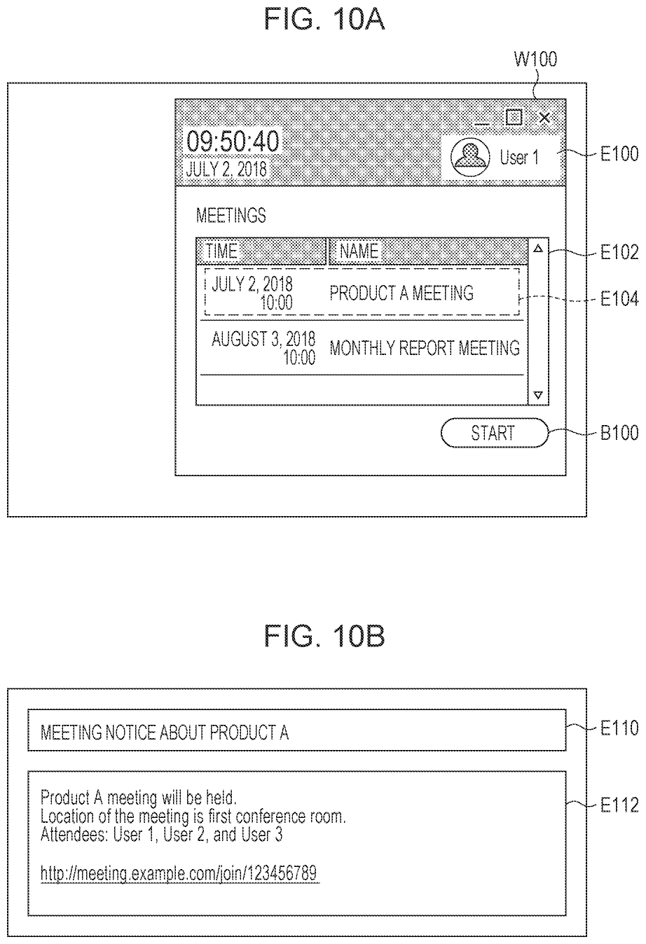

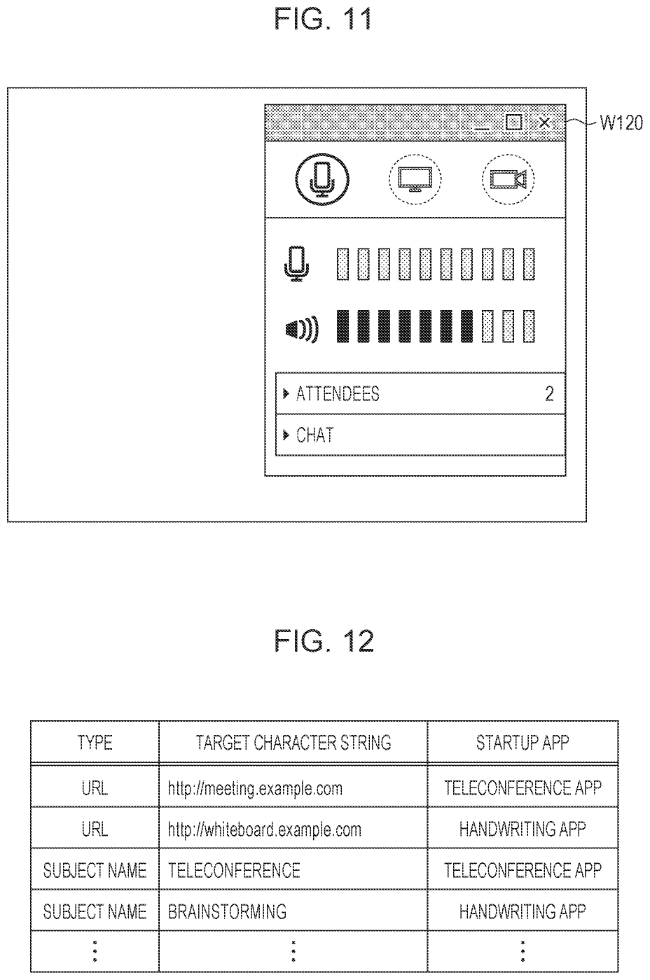

An operation example is described with reference to FIGS. 10A and 10B and 11. FIG. 10A illustrates an example of a display screen W100 displaying a list of the schedule information related to a user operating the display apparatus 20. The display screen W100 includes a region E100 used to display the user ID of a user operating the display apparatus 20, a region E102 used to display in a list the schedules of the user operating the display apparatus 20, and a start button B100 used to provide an instruction to start the meeting.

The display apparatus 20 displays on the region E102 the schedule name and the start date and time on each piece of the schedule information. The user operating the display apparatus 20 checks the schedule name and the start date and time and selects a schedule for which an instruction to start the meeting has been provided. For example, a region E104 indicating one schedule may now be selected from among schedules displayed on the region E102. When the user operating the display apparatus 20 selects the start button B100, the display apparatus 20 determines that an instruction to start the meeting displayed on the region E104 has been provided.

FIG. 10B illustrates an example of the email contents of the invitation email corresponding to the schedule displayed on the region E104 in FIG. 10A. Referring to FIG. 10B, the invitation email includes as the email contents a subject name E110 and a text body E112. The text body E112 of the invitation email includes a URL as the startup information. The URL included in the text body E112 is the URL corresponding to the teleconference app as the startup app.

FIG. 11 illustrates an example of the display screen W120 of the teleconference app that starts up when the user selects the start button B100 in FIG. 10A. By simply operating to provide the instruction to start the meeting, the user operating the display apparatus 20 may start up an app in accordance with the URL described in the text body of the email contents of the invitation email.

In accordance with the first embodiment, the display apparatus 20 acquires the invitation email and starts up the app at the beginning of the meeting in accordance with the startup information by using as the startup information the URL including the specific character string from among the URLs described in the invitation email. In this way, the user is free from checking the invitation email, searching for the app to be started up, and starting the app.

In accordance with the first embodiment, the subject name and the text body described in the invitation email are stored as the email contents, namely, as part of the email information. The management server 10 may store the invitation email itself. In such a case, when the schedule information is stored in accordance with the invitation email, the management server 10 may further store on the memory 120 a management table that associates the schedule ID of the stored schedule information with the invitation email. In this way, the management table associates the invitation email and the schedule information.

In step S110 of the process, the email acquisition unit 202 acquires the email from the management server 10 by transmitting to the management server 10 an email acquisition request for an email stored on the management server 10. By transmitting the schedule ID together with the email acquisition request, the email acquisition unit 202 acquires from the management server 10 the invitation email corresponding to the schedule ID. The email acquisition unit 202 stores on the invitation email storage region 258 the invitation email received from the management server 10.

In step S152, the email analyzing unit 210 extracts the text body of the invitation email with header information excluded from the invitation email and inputs the extracted text body to the URL extracting unit 212. In this way, the URL extracting unit 212 may output to the controller 200 the list of URLs included in the text body of the invitation email as the analysis result data.

### 2. SECOND EMBODIMENT

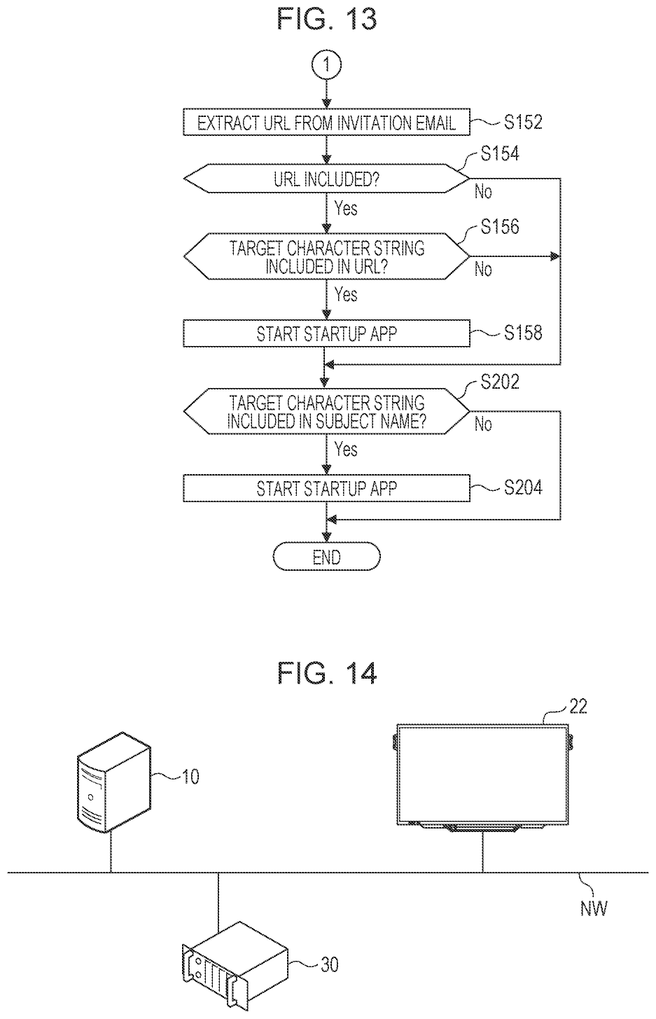

A second embodiment is described below. The second embodiment performs the process of the first embodiment and additionally performs a process to set the subject name to be the startup information if a specific keyword is included in the subject name of the email contents of the invitation email. The second embodiment is implemented in a flowchart in FIG. 13 replacing the flowchart in FIG. 9 of the first embodiment. Like elements and operations are identified with like reference numerals, and the discussion thereof is not repeated.

Referring to FIG. 12, the startup app information stored on the startup app information storage region 254 of the second embodiment is described below. The startup app information storage region 254 of the second embodiment stores the startup app information having the subject name as the type of the startup information in addition to the startup app information having the URL as the type of the startup information. For example, the type of the startup information may be a “subject name,” the target character string may be a “teleconference”, and the startup app may be a “teleconference app.” If the “teleconference” is included in the subject name of the invitation email, the “teleconference app” is to be started up when the meeting begins.

The process of the second embodiment is described with reference to FIG. 13. Operations following the operation in step S158 that starts up the app in response to the URL described in the invitation email are described below. The controller 200 reads the email contents of the invitation email that is stored on the invitation email storage region 258 in step S110 by the email acquisition unit 202. The controller 200 then determines whether the target character string stored in the startup app information having the “subject name” as the type of the startup information is included in the subject name of the read email contents (step S202).

If the target character string is included in the subject name of the email contents, the controller 200 starts up the corresponding startup app (the process proceeds from the yes branch of step S202 to step S204). If the target character string is not included in the subject name of the email contents, the process ends (no branch from step S202).

As described above, the determination as to whether the target character string is included or not is performed on the two pieces of information including the URL described in the text body of the invitation email and the subject name of the invitation email. The determination as to whether the target character string is included may be performed only on the subject name of the invitation email. The determination as to whether the target character string is included in the text body of the invitation email may be performed by applying the process described above. If the target character string is included in the text body of the invitation email, the corresponding startup app may be started up.

In accordance with the second embodiment, not only the URL including the target character string in the text body of the email but also the subject name of the email including the target character string may be set to be the startup information.

### 3. THIRD EMBODIMENT

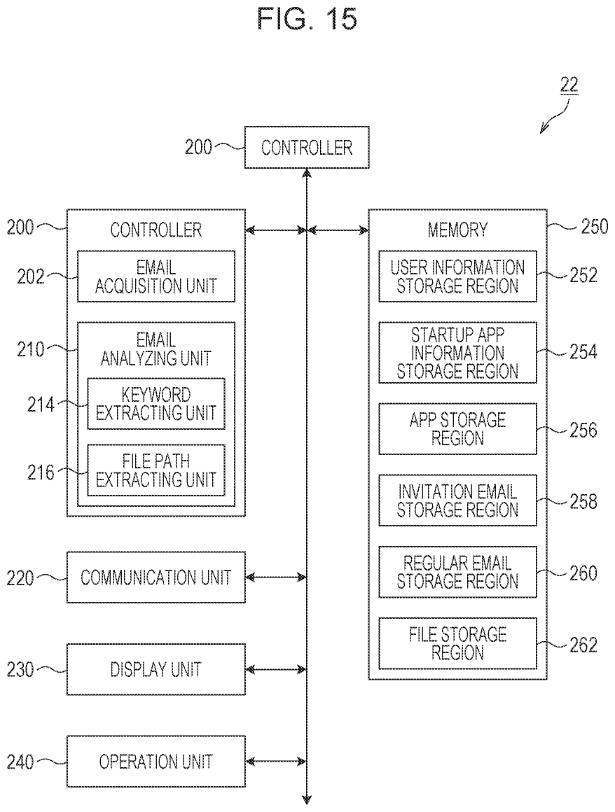

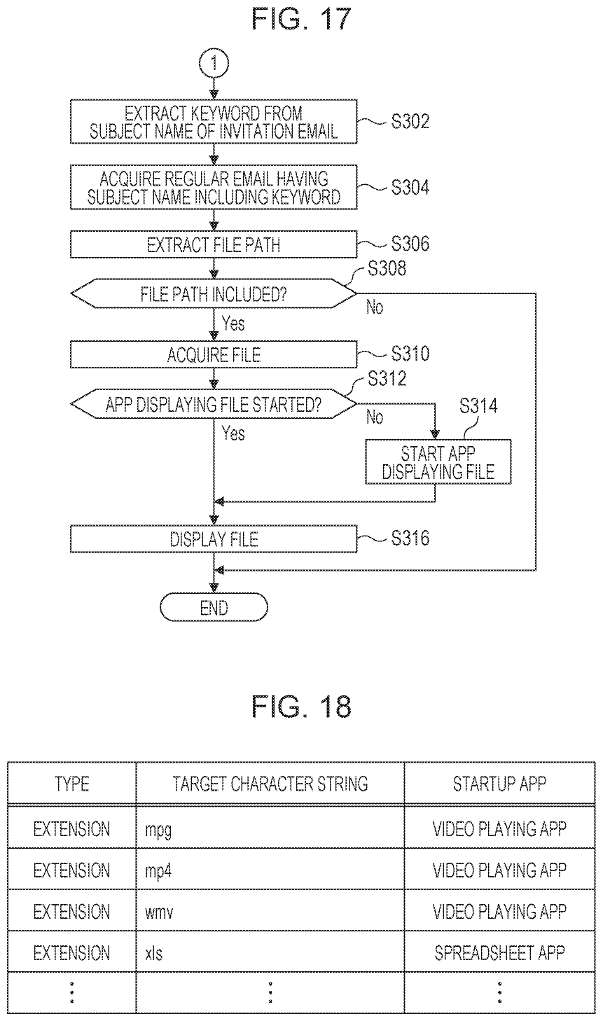

A third embodiment is described below. In the third embodiment, a file path is set to be the startup information in addition to the process of the first embodiment. The third embodiment is implemented in a configuration in FIG. 14, a block diagram in FIG. 15, and a flowchart in FIG. 17 respectively replacing the configuration in FIG. 1, the block diagram in FIG. 5, and the flowchart in FIG. 9 of the first embodiment. Like elements and operations are designated with like reference numerals, and the discussion thereof is not repeated herein.

### 3.1 Configuration

FIG. 14 illustrates the whole configuration of the third embodiment. In the third embodiment, the management server 10 and a display apparatus 22 are connected to the network NW, and a file server 30 is additionally connected to the network NW.

The file server 30 includes a memory used to store a file and a communication unit used to transmit or receive a file to or from an external device. The file server 30 has a region which a user is able to store a file on or read a file from. The user may store a file for use in a meeting on the region enabled to store the files of the file server 30.

### 3.2 Functional Configuration of Display

The functional configuration of a display apparatus 22 of the third embodiment is described with reference to FIG. 15. The display apparatus 22 is different from the display apparatus 20 in that the email analyzing unit 210 includes a keyword extracting unit 214 and a file path extracting unit 216. Furthermore, the memory 250 further includes a regular email storage region 260 and a file storage region 262.

A regular email is an email other than the invitation email. Specifically, the regular email is an email that the management server 10 receives at a timing other than the timing of the reception of the schedule information of the meeting. The regular email may be transmitted to the management server 10 by the user. If the management server 10 functions as an email server, the email contents of the email transmitted by the user may be stored as the email information.

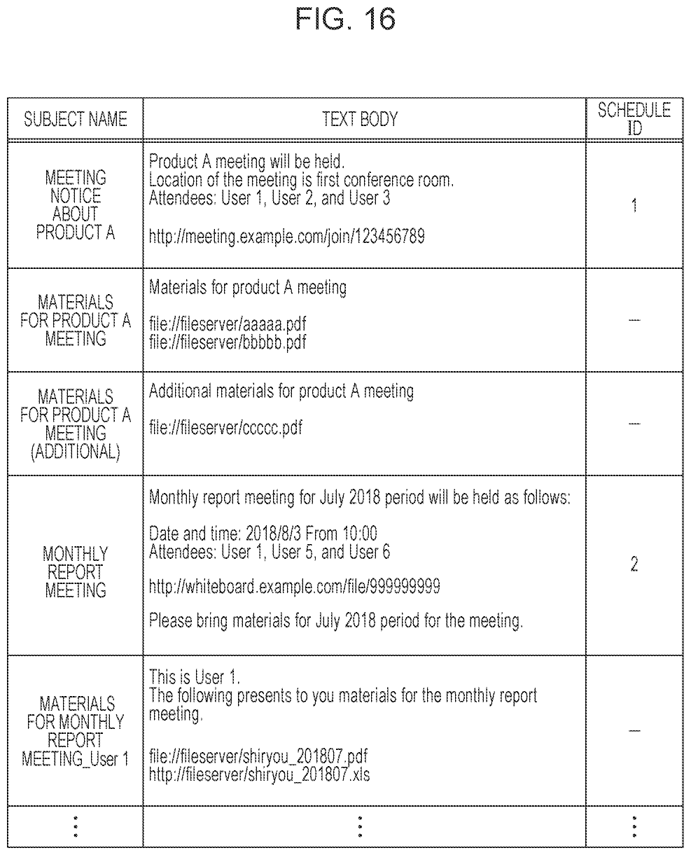

The email information storage region 124 of the third embodiment is described with reference to FIG. 16. In accordance with the third embodiment, the management server 10 stores the invitation email and the regular email on the email information storage region 124. Since the regular email is an email that the management server 10 receives at a timing other than the timing of the reception of the schedule information of the meeting, the corresponding schedule ID is difficult to identify. Referring to FIG. 16, the subject name and the text body as the email contents are stored in the email information of the regular email (for example, the email having the subject name “Materials for product A meeting”) but the corresponding schedule ID is not stored in the email information of the regular email.

In accordance with the third embodiment, an email with the corresponding schedule ID stored in the email information is classified as an invitation email, and an email with the corresponding schedule ID not stored in the email information is classified as a regular email. The management server 10 may use the management table that associates the email with the schedule information. In such a case, an email associated with the schedule information is classified as an invitation email and an email not associated with the schedule information is classified as a regular email.

The regular email may be an email that a user having received an invitation email transmits to attendees of a meeting to inform them of a location of a file to be used in the meeting. The regular email may be transmitted by the management server 10 or another apparatus different from the management server 10. When the apparatus different from the management server 10 transmits a regular email, the management server 10 acquires the email information from the server having transmitted the regular email and stores the email information on the email information storage region 124.

The keyword extracting unit 214 extracts a keyword from the subject name of the email and outputs the analysis result data. The keyword may be the subject name of the email or a specific character string included in the subject name of the email.

The file path extracting unit 216 identifies a file path included in the text body of the email or a file path indicating the location where the file attached to the email is stored. The file path extracting unit 216 outputs a list of the identified file paths as the analysis result data.

The email analyzing unit 210 receives request information together with the contents of the email. The request information indicates contents desired as the analysis result data. For example, in order to acquire a keyword in the subject name of the email, a “keyword” as the request information is input together with the email contents to the email analyzing unit 210. In this case, the email analyzing unit 210 inputs the subject name included in the email contents to the keyword extracting unit 214. The keyword extracting unit 214 outputs the keyword as the analysis result data. In order to acquire the list of file paths included in the subject name of the email, a “file path” as the request information is input together with the email contents to the email analyzing unit 210. In this case, the email analyzing unit 210 inputs the text body included in the email contents to the file path extracting unit 216. The file path extracting unit 216 outputs the list of file paths as the analysis result data.

The regular email storage region 260 stores the email contents of the regular email out of the email information stored on the email information storage region 124 of the management server 10.

In order to receive the regular email from the management server 10, the email acquisition unit 202 in the display apparatus 20 transmits to the management server 10 the email content acquisition request together with the narrowing condition “corresponding schedule ID=none” that narrows the email contents to be acquired from the management server 10. In order to acquire the regular email having the subject name including a specific keyword (such as “abc”), the email acquisition unit 202 transmits to the management server 10 the email content acquisition request together with the narrowing condition “corresponding schedule ID=none and subject name “abc”).

In the same way as described with reference to the first embodiment, the management server 10 transmits to the display apparatus 20 the email contents satisfying the narrowing condition from the email information stored on the email information storage region 124. The email acquisition unit 202 stores the email contents received from the management server 10 on the regular email storage region 260.

### 3.3 Process

The process of the third embodiment is described with reference to FIG. 17. Operations in steps following step S110 to acquire the invitation email are described. The controller 200 inputs to the email analyzing unit 210 the email contents of the invitation email stored on the invitation email storage region 258 and the keyword as the request information. The email analyzing unit 210 reads the subject name included in the input email contents and inputs the read subject name to the keyword extracting unit 214. The keyword extracting unit 214 extracts the keyword included in the input subject name (step S302) and outputs the keyword as the analysis result data to the controller 200. In this way, the controller 200 may acquire the keyword included in the subject name of the email contents of the invitation email.

The email acquisition unit 202 acquires from the management server 10 via the communication unit 220 the regular email including the keyword acquired as the analysis result data in step S302 (step S304). The email acquisition unit 202 transmits the email content acquisition request and the narrowing condition to the management server 10. The narrowing condition specifies that no schedule ID is present and the subject name includes the keyword included in the analysis result data. The email acquisition unit 202 also stores on the regular email storage region 260 the email contents of the regular email received from the management server 10.

The controller 200 inputs to the file path extracting unit 216 the email contents of the invitation email stored on the invitation email storage region 258, the email contents of the regular email stored on the regular email storage region 260, and the file path serving as the request information. The file path extracting unit 216 extracts the file path from the text body of the input email contents (step S306) and outputs the list of file paths as the analysis result data to the controller 200.

The controller 200 determines whether the analysis result data output from the file path extracting unit 216 includes one or more file paths (step S308). If the analysis result data includes no file path, the process ends (no branch from step S308).

If the analysis result data includes one or more file paths, the controller 200 reads the file paths one by one from the analysis result data and acquires files stored on the file server 30 in accordance with the file paths (step S310). The controller 200 stores the acquired files on the file storage region 262.

The controller 200 determines whether the app displaying the file acquired in step S310 has started up (step S312). The app displaying the file may support a viewer functionality of viewing a file or a functionality of reading a file and displaying a preview of the file. If the startup app started up in step S158 is able to display a file, the controller 200 determines in step S312 that the app displaying the file has started up (yes branch from step S312). If the controller 200 determines in step S312 that the app displaying the file has not started up, the controller 200 starts up the app displaying the file (proceeding from no branch from step S312 to step S314).

The controller 200 displays the file acquired in step S310 by using the app displaying the file (step S316). It will be noted that if the file path extracting unit 216 has acquired multiple file paths as the analysis result data, the controller 200 displays a file on a per file path basis. For example, if the analysis result data includes three file paths, the controller 200 displays the files by using the app displaying three files.

### 3.4 Operation Example

An operation performed with the email information illustrated in FIG. 16 stored on the email information storage region 124 in the management server 10 is described below. If the subject name of the invitation email is the “Meeting notice about product A,” the keyword extracting unit 214 outputs to the controller 200 the analysis result data indicating that the keyword is “Product A meeting.” The email acquisition unit 202 acquires from the management server 10 the email contents of the regular email having the “Product A meeting” as the subject name. As a result, the controller 200 acquires from the management server 10 the email contents of the regular email having the “Materials for product A meeting” and the “Materials for product A meeting (additional)” as the subject name.

The email contents of the regular email acquired from the management server 10 are input to the file path extracting unit 216. The file path extracting unit 216 extracts “file://fileserver/aaaaaa.pdf” and “file://fileserver/bbbbbb.pdf” as the file paths from the text body of the email having the “Materials for product A meeting” as the subject name. The file path extracting unit 216 also extracts “file://fileserver/cccccc.pdf” as the file path from the text body of the email having the “Materials for product A meeting (additional)” as the subject name. The file path extracting unit 216 outputs data listing these three file paths as the analysis result data to the controller 200.

The controller 200 reads the analysis result data output from the file path extracting unit 216 and acquires the corresponding file. If “fileserver” included in the file path represents the file server 30, three files, namely, aaaaaa.pdf, bbbbbb.pdf, and cccccc.pdf are acquired from the file server 30. The controller 200 stores the acquired files onto the file storage region 262.

The controller 200 displays the files stored on the file storage region 262. In this way, when the user commences the meeting, the files related to the commenced meeting are displayed.

In accordance with the third embodiment, a file is acquired in accordance with a file path described in the email related to a meeting and an attached file, and an app displaying the acquired file is started. The user is thus free from searching for the app displaying the file and starting up the app.

### 4. FOURTH EMBODIMENT

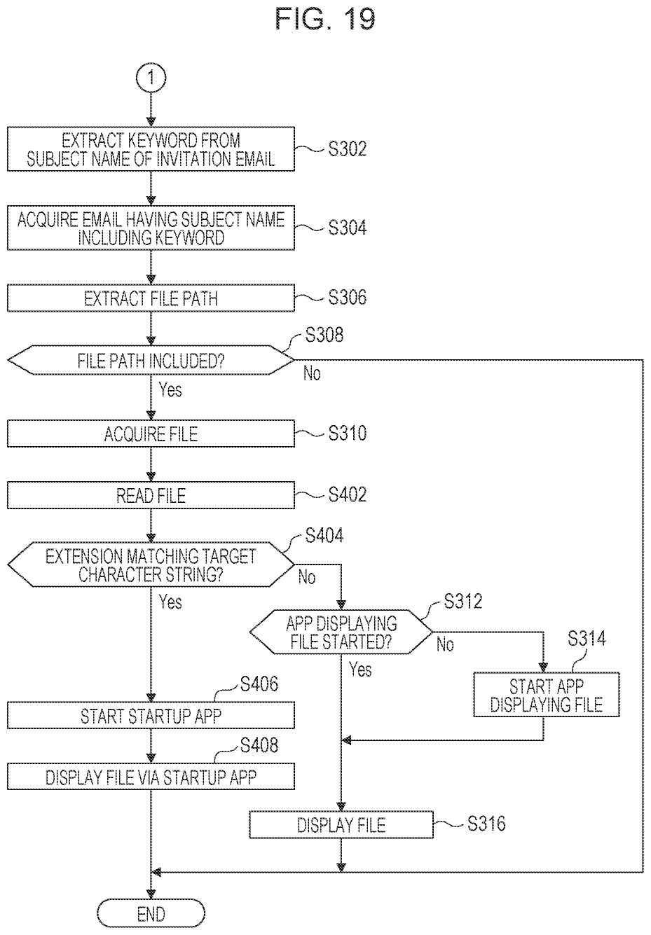

A fourth embodiment is described below. The fourth embodiment is identical to the third embodiment in that the file acquired from the file server 30 is started up. In accordance with the fourth embodiment, however, the extension of a file name included in the file path is used as the startup information. The fourth embodiment is implemented in a process illustrated in FIG. 19 in place of the process illustrated in FIG. 17 of the third embodiment. Like elements and operations are designated with like reference numerals, and the discussion thereof is not repeated herein.

The startup app information stored on the startup app information storage region 254 of the fourth embodiment is described with reference to FIG. 18. The startup app information storage region 254 of the fourth embodiment stores the startup app information having an extension as the type of the startup information. The type of the startup information of the startup app information may be an “extension,” the target character string may be “mpg,” and the startup app may be a “video playing app.” If the file path of the file having the extension mpg is included in the text body of the email contents, the video playing app is started up, and the file represented by the file path is displayed. Similarly, the type of the startup information of the startup app information may be an “extension,” a target character string may be “xls,” and a startup app may be a “spreadsheet app.” If the file path of a file having the extension mpg is included in the text body of the email contents, the spreadsheet app is started up, and the file represented by the file path is displayed. If the extension of the displayed file is not stored in the startup app information, the app displaying the file described with reference to the third embodiment is used to display the file.

Referring to FIG. 19, the process of the fourth embodiment is described below. Operations following step S310 that acquires the file in accordance with the analysis result data output from the file path extracting unit 216 are described. The controller 200 reads one by one the files stored on the file storage region 262 (step S402). If the extension of the file name of the read file matches one of the specific character strings of the startup app information having the extension as the type of the startup information, the controller 200 starts up the corresponding startup app (proceeding from yes branch from step S404 to step S406). The controller 200 displays the file by using the started startup app (step S408).

If the extension of the file name of the read file does not match any one of the specific character strings of the startup app information having the extension as the type of the startup information, the controller 200 starts up the app displaying the file if the app displaying the file has not started yet (proceeding from no branch from step S404 to step S314). The controller 200 displays the file read in step S402 by using the app displaying the file (step S316).

An operation performed when the startup app information is stored on the startup app information storage region 254 as illustrated in FIG. 18 is described below. The analysis result data output from the file path extracting unit 216 may now include three file paths including a file path having an extension “mpg,” a file path having an extension “xls,” and a file path having an extension “pdf.” In such a case, the controller 200 acquires the files in step S310 and reads the acquired files one by one.

If the file having the extension mpg is read, the controller 200 displays the file by starting the video playing app. If the file having the extension xls is read, the controller 200 displays the file by starting the spreadsheet app. If the file having the extension pdf is read, the controller 200 displays the file by starting the app to display the file. The controller 200 thus starts up the three apps.

In accordance with the fourth embodiment, if the app to display the file is not appropriate to display a particular type of file, an app appropriate to display the particular type of file is started up and then the file is displayed by that appropriate app.

In accordance with the fourth embodiment, if the extension of the file read from the file storage region 262 does not match any of the specific character strings of the extensions stored in the startup app information having the extension as the type of the startup information, the app to display the file is started up. Alternatively, the app may not necessarily have to be started up. In such a case, the app to display a file including an extension other than the extension stored in the startup app information having the extension as the type of the startup information is not started up.

### 5. FIFTH EMBODIMENT

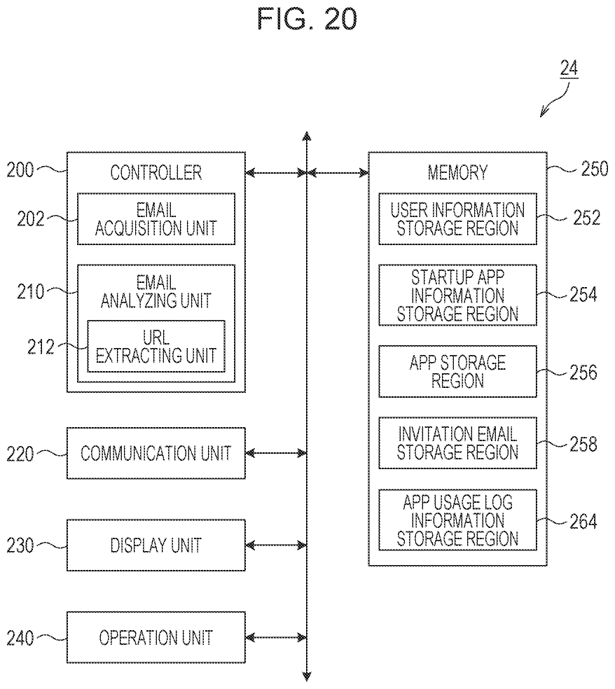

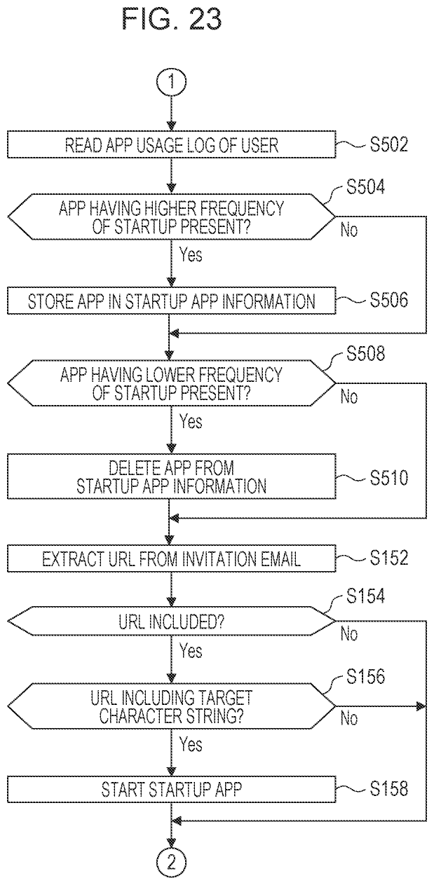

A fifth embodiment is described below. In the fifth embodiment, the process of the first embodiment is performed and in an additional process, an app frequently used by users is started when a meeting starts. The fifth embodiment is implemented in a configuration in FIG. 20 and a process in FIG. 23 respectively replacing the configuration in FIG. 5 and the process in FIG. 9 of the first embodiment. Like elements and operations are designated with like reference numerals, and the discussion thereof is not repeated herein.

### 5.1 Functional Configuration

Referring to FIG. 20, the functional configuration of a display apparatus 24 of the fifth embodiment is described. The display apparatus 24, different from the display apparatus 20, further includes an app usage log information storage region 264 in the memory 250.

Referring to FIG. 22, the app usage log information storage region 264 is described. The app usage log information storage region 264 stores the app usage log information indicating log information of an app used by the user during a meeting, namely, a period of time from the beginning to the end of the meeting. As illustrated in FIG. 22, the app usage log information includes a user ID identifying the user (for example, “User 1”), a schedule ID identifying the schedule information corresponding to the meeting held (for example, “1”), an app used by the user during the meeting (for example, a “web browser”).

If multiple apps are used during the meeting held, multiple apps are stored in an app usage log information using app. If there is no app used by the user during the meeting, nothing is stored in the app usage log information using app. The app is determined to be used when the app is actually operated by the user. For example, an app is started up but is terminated later without the user operating it, or the meeting may possibly end before the user operates the app. In such a case, the app is not used and is not stored as an used app in the app usage log information. In this way, even if the display apparatus 24 starts at the beginning of the meeting the app that has been frequently used only for a temporary period of time, the app is terminated without being used. The app is thus determined to be not a frequently used app and is not started up any longer by the display apparatus 24 at the beginning of the meeting.

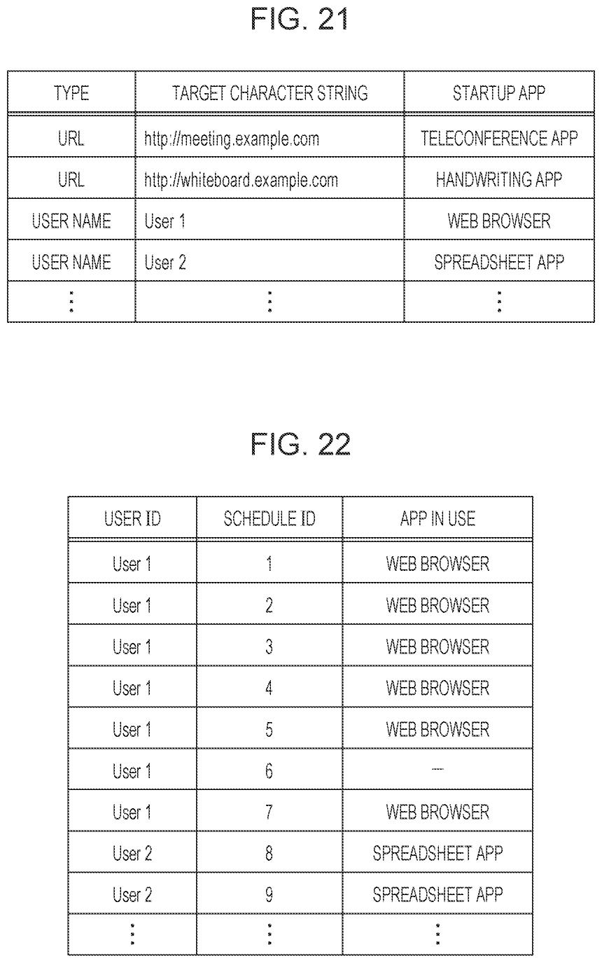

Referring to FIG. 21, the startup app information storage region 254 of the fifth embodiment is described. The startup app information storage region 254 of the fifth embodiment stores not only the startup app information having a URL as the type of the startup information but also the startup app information having a user ID as the type of the startup information. For example, the type of the startup information of the startup app information may be a “user ID,” the target character string may be a “User 1,” and the startup app may be a “web browser.” If the user ID of the user operating the display apparatus 24 is the User 1, the web browser is started up.

### 5.2 Process

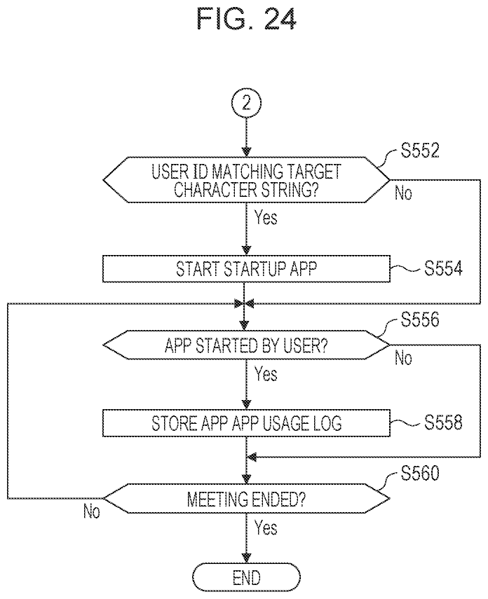

The process of the fifth embodiment is described with reference to FIGS. 23 and 24. Operations following step S110 that acquires the invitation email are described. The controller 200 reads the app usage log information of the user operating the display apparatus 24 from the app usage log information storage region 264 and determines on each app stored as the app usage log information whether an app having a higher frequency of usage is present (proceeding from step S502 to step S504).

In accordance with the fifth embodiment, the app having a higher frequency of usage is determined to be an app satisfying a frequent usage app condition. The frequent usage app condition is satisfied by an app that is determined to have a higher frequency of usage. The frequent usage app condition is described below. In the following discussion, n and m refer to integer values stored on the memory 250 in the display apparatus 24. The integer values may be determined in the display 24 in advance or by the user.

### (1) Number of Uses in Recent Period of Time

If an app has been used more than m times from among recent n meetings, it is determined that the frequent usage app condition is satisfied. For example, if an app has been used three times or more in the recent five meetings with n=5 and m=3, the app is determined as satisfying the frequent usage app condition. That app is thus determined to be an app having a higher frequency of startup.

### (2) Number of Consecutive Uses

An app that has been consecutively used at the recent five meetings is determined to satisfy the frequent usage app condition. For example, an app that has been started up at the recent 3 meetings with with n=3 is determined to satisfy the frequent usage app condition. The app is thus determined to be an app having a higher frequency of startup.

### (3) Previously Used App

A previously used app corresponds to the case (2) with n=1. In this case, an app used after the beginning of a previous meeting (namely, the previously used app) is determined to satisfy the frequent usage app condition. The app is thus determined to be an app having a higher frequency of startup.

The frequent usage app condition is not limited to the conditions described above. For example, the app usage log information may include an action taken by the user on an app, such as an operation time period of an app, the number of clicks performed on the app, or the number of inputs on a keyboard. A determination as to whether the frequency of usage of the app is higher or not may be made in response to user actions performed on the app, such as the operation time period of the app exceeding a specific period of time.

If an app having a higher frequency of usage is present, startup app information is stored on the startup app information storage region 254. The startup app information has the user ID as the type of the startup information, the user ID of the user operating the display apparatus 24 as the target character string, and the app having a higher frequency of usage as the startup app (the process proceeds from yes branch from step S504 to step S506).

In accordance with the app usage log information, the controller 200 determines whether an app having a lower frequency of usage is present for the user operating the display apparatus 24 (step S508). The determination as to whether the app is lower in the frequency of usage may be made as below. For example, an app that satisfies a predetermined condition as in step S504 may be determined to be an app having a lower frequency of usage or an app that does not satisfy the frequent usage app condition any longer may be determined to be an app having a lower frequency of usage.

If the startup app information for the user operating the display apparatus 24 is stored on the startup app information storage region 254, the controller 200 may determine whether the startup app stored in the startup app information is lower in the frequency of usage.

If an app having a lower frequency of usage is present, the controller 200 deletes the app having the lower frequency of usage from the startup apps for the user operating the management server 10 (proceeding from yes branch from step S508 to step S510).

Operations following step S158 that starts up the app with the startup information included in the text body of the invitation email are described below. Referring to FIG. 24, the controller 200 determines whether the user ID of the user operating the display apparatus 24 matches one of the target character strings of the startup app information having the user ID as the type of the startup information (step S552). If the user ID of the user operating the display apparatus 24 matches one of the target character strings of the startup app information having the user ID as the type of the startup information, the controller 200 starts up the startup app corresponding to the user ID of the user operating the display apparatus 24 (proceeding from yes branch from step S552 to step S554).

The controller 200 determines whether the user operating the display apparatus 24 has started the app. If the app has started, the controller 200 stores the app usage log information of the started app on the app usage log information storage region 264 (proceeding from yes branch from step S556 to step S558). Specifically, the app usage log information stored on the app usage log information storage region 264 by the controller 200 includes the user ID of the user operating the display apparatus 24, the schedule ID of the schedule information corresponding to the schedule selected in step S110, and the started app.

The controller 200 determines whether the meeting has ended. If the meeting has ended, the controller 200 ends the process (yes branch from step S560). If the meeting has not yet ended, the controller 200 returns to step S556 (proceeding from no branch from step S560 to step S556). The determination as to whether the meeting has ended may be made as described below. For example, the controller 200 causes the display unit 230 to display a button that prompts the user to indicate the end of the meeting. If the user selects the button, the controller 200 determines that the meeting has ended. If the schedule information includes scheduled finish date and time and the present time passes the scheduled finish date and time, the controller 200 may determine that the meeting has ended.

Through the above process, after the beginning of the meeting, the app used by the user operating the display apparatus 24 is stored as the app usage log information on the app usage log information storage region 264. When another meeting is started by the same user, an app may be stored on or deleted from the startup app information storage region 254 in accordance with the app usage log information stored on the app usage log information storage region 264. If the startup app for the user operating the display apparatus 24 is present on the startup app information storage region 254, that app is started.

In accordance with the fifth embodiment, the app that is used by the user of the display apparatus 24 with a higher frequency of usage may be started with the user ID of the user operating the display apparatus 24 being as the startup information. The user operating the display apparatus 24 is thus free from searching for an app having a higher frequency of usage and starting up the app. Operational convenience may thus be increased.

### 6. MODIFICATIONS

The disclosure is not limited to the embodiments described above, and a variety of modifications is possible. An embodiment resulting from combining, in the embodiments, technical elements that are appropriately modified without departing from the scope of the disclosure may fall within the scope of the disclosure. As long as the consistency is maintained in the processes described above, the order of the steps may be modified or a subpart of the steps may be deleted.

The embodiments have been separately described for convenience of explanation. The embodiments may be combined in a technically feasible range and started up. For example, if the first embodiment and the third embodiment in a combined form are started up, an app may be started in accordance with the URL described in the invitation email and the file path described in the invitation email and the regular email.

A program running on each of the apparatuses in each of the embodiments is a program (program controlling a computer) that controls a central processing unit (CPU) or the like to implement the functionalities of each embodiment. Information to be handled by each of the apparatuses may be temporarily stored on a temporary storage device (such as a random-access memory (RAM)) during the process, then later stored on a storage device, such as a read-only memory (ROM), a hard disk drive (HDD), or a solid state drive (SSD), and read, corrected, and re-written as appropriate by the CPU.

Storage medium storing the program may be a semiconductor medium (such as a ROM or a non-volatile memory card), an optical recording medium or a magneto-optical recording medium (such as a digital versatile disc (DVD), a magneto-optical disc (MO), a mini disc (MD), a compact disc (CD), or a blu-ray disk (BD)), or a magnetic recording medium (such as a magnetic tape or a flexible disk). The functionalities of the embodiments are implemented by starting up the loaded program. Alternatively, the functionalities of the embodiments may be implemented by performing the processes in response to instructions of the program in concert with another operating system or another application program.

To circulate the program in the market, the program may be stored on a portable recording medium or may be transmitted to a server computer via a network, such as the Internet. In such a case, a storage device of the server computer falls within the scope of the disclosure.

The present disclosure contains subject matter related to that disclosed in Japanese Priority Patent Application JP 2018-105202 filed in the Japan Patent Office on May 31, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a communication port that communicates with an external device;
a controller that controls the information processing apparatus; and
a memory that stores log information on an application that has been used,
wherein the controller performs control to determine in accordance with the log information whether a frequent usage application satisfying a frequent usage application condition is present when an email has been received via the communication port, and to start up the frequent usage application when the frequent usage application is present.

2. The information processing apparatus according to claim 1, wherein the information processing apparatus is connected to a conference server that is enabled to reserve a conference in accordance with an email, and
wherein the memory stores an application as the log information when a user of the information processing apparatus has used the application for a period of time from a commencement to an end of the conference.

3. The information processing apparatus according to claim 1, wherein
the controller determines a startup frequency of the application based on the log information, and
the controller determines whether the application satisfying the frequent usage application condition using the startup frequency of the application.

4. The information processing apparatus according to claim 3, wherein the controller determines that the application satisfies the frequent usage application condition if the application has been used a predetermined times or more with respect to the number of the recent meetings.

5. The information processing apparatus according to claim 3, wherein the controller determines that the application satisfies the frequent usage application condition if the application has been consecutively used a predetermined times or more with respect to the number of the recent meetings.

6. The information processing apparatus according to claim 1, wherein
the memory stores the frequent usage application satisfying a frequent usage application condition as startup application information, and
the controller performs control to start up the application stored as the startup application information when the email has been received.

7. The information processing apparatus according to claim 6, wherein
the controller determines in accordance with the log information whether a lower frequent usage application is present, and
the controller deletes the lower frequent usage application from the startup application information when the lower frequent usage application is present.

8. The information processing apparatus according to claim 3, wherein
the memory stores the frequent usage application satisfying a frequent usage application condition as startup application information, and
the controller performs control to start up the application stored as the startup application information when the email has been received.

9. The information processing apparatus according to claim 8, wherein
the controller determines in accordance with the log information whether a lower frequent usage application is present, and
the controller deletes the lower frequent usage application from the startup application information when the lower frequent usage application is present.

10. The information processing apparatus according to claim 1, wherein when the controller receives the email, the controller performs control, by using information that identifies user as startup information, to start up the frequent usage application that satisfies the frequent usage application condition.

11. The information processing apparatus according to claim 1, wherein the controller determines whether the application satisfies the frequent usage application condition in response to user actions performed on the application.

12. The information processing apparatus according to claim 11, wherein the controller determines that the application satisfies the frequent usage application condition if an operation time period of the application exceeds a specific period of time.

13. A method for starting up an application, the method comprising:
storing log information on an application that has been used,
determining in accordance with the log information whether a frequent usage application satisfying a frequent usage application condition is present when an email has been received, and
starting up the frequent usage application when the frequent usage application is present.
